(19) United States
(12) Patent Application Publication
(10) Pub. No.: US 2025/0120547 A1
(43) Pub. Date: Apr. 17, 2025

(54) SYSTEM AND METHOD FOR PROCESSING FOOD WASTE

(71) Applicant: Food Cycle Science Corporation, Cornwall (CA)

(72) Inventors: Bradley Michael Campbell CREPEAU, Ottawa (CA); Danylo VARSHAVSKY, Toronto (CA); Philip LO, Ottawa (CA); Thanh TANG, Ottawa (CA)

(21) Appl. No.: 18/495,117

(22) Filed: Oct. 26, 2023

Related U.S. Application Data
(60) Provisional application No. 63/544,058, filed on Oct. 13, 2023.

(51) Int. Cl. A47J 43/07; A47J 43/046

(52) U.S. Cl. CPC A47J 43/07; A47J 43/046

(57) ABSTRACT

A device may include a base. A device may include a housing configured to be attached to the base. A device may include a bucket. A device may include a bucket housing configured receive the bucket and to be attached to the base and configured to be a supporting structure for the food processor. A device may include a lid configured on a top portion of the food processor, wherein the lid comprises a lid lower circular member on a bottom portion of the lid in which the lid lower circular member has a lid air flow cavity configured to enable humid air from the bucket to flow to a fan. A device may include a filter that receives and filters the humid air.

### PRIORITY INFORMATION

The present application claims the benefit of U.S. Patent Provisional Application No. 63/544,058, filed Oct. 13, 2023, the contents of which are incorporated herein by reference in their entirety.

### FIELD OF THE INVENTION

The present disclosure relates to food processors that process waste food and further to new innovations related to improvements in the structural design and use of food processors.

### BACKGROUND

Waste food processors continue to gain traction in the marketplace. Food processors typically will receive waste food and process the waste food to generate essentially an organic dirt byproduct which can be easily discarded. A food processor can reduce waste volume in the process by 90% and create a disinfected, odorless and nutrient-rich soil amendment that can be used in a garden. Food processors typically include features such as a heating component, a bucket, a grinding mechanism, and a fan that causes airflow through the bucket to remove moisture from the waste food as it is being processed.

### BRIEF SUMMARY

What is needed in the art is continued improvement in the design of waste food processors that continuously improve the volumetric efficiency but also add to the ease of using the food processors with respect to air flow, heat exchange, filter use and replacement, and other benefits. This disclosure introduces new designs and features associated with a food processor.

In some aspects, the techniques described herein relate to a food processor including: a base; a housing configured to be attached to the base; a bucket; a bucket housing configured receive the bucket and to be attached to the base and configured to be a supporting structure for the food processor; a lid configured on a top portion of the food processor, wherein the lid includes a lid lower circular member on a bottom portion of the lid in which the lid lower circular member has a lid air flow cavity configured to enable humid air from the bucket to flow to a fan; and a filter that receives and filters the humid air.

In some aspects, the techniques described herein relate to a method including: receiving food waste in a bucket of a food processor, wherein the food processor is configured with a base, a lid and a housing; processing the waste food, wherein a fan draws humid air from a bucket via a lid air flow cavity in the lid on a bottom side of the lid; drawing the humid air through a filter assembly configured in the food processor such that a filter exterior surface of the filter assembly is configured to also become a portion of an exterior wall of the housing to generate filtered air; and causing the filtered air to exit the housing out a top surface of the housing.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE SEVERAL VIEWS OF THE DRAWINGS

Illustrative aspects of the present application are described in detail below with reference to the following figures:

FIG. 1 illustrates an exploded view of a waste food processor in accordance with some aspects of this disclosure;

FIG. 2 illustrates a partially assembled waste food processor in accordance with some aspects of this disclosure;

FIG. 3A illustrates an assembled food processor in accordance with some aspects of this disclosure;

FIG. 3B illustrates an airflow through the food cycler housing in accordance with some aspects of this disclosure;

FIG. 3C illustrates cross-sectional view of a bucket and bucket housing showing airflow between the two components in accordance with some aspects of this disclosure;

FIG. 3D illustrates a top view of a bucket and bucket housing and airflow between the two components in accordance with some aspects of this disclosure;

FIG. 4A illustrates an exploded view of a bucket in accordance with some aspects of this disclosure;

FIG. 4B illustrates an exploded view of the heat plate and drivetrain in accordance with some aspects of this disclosure;

FIG. 4C illustrates a cross-sectional view of a bucket in accordance with some aspects of this disclosure;

FIG. 4D illustrates an exploded view of the drivetrain and respective brackets in accordance with some aspects of this disclosure;

FIG. 5 illustrates a method embodiment in accordance with some aspects of this disclosure;

FIG. 6 illustrates a data management system in accordance with some aspects of this disclosure;

FIG. 7 illustrates a data management method in accordance with some aspects of this disclosure; and

FIG. 8 shows an example of a system for implementing certain aspects of the present technology.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

As mentioned above, disclosed herein is an improved waste food processor with a number of new improvements over prior art systems. A goal of the disclosed food processor is to optimize the shape of the food processor based on the size of a bucket. The system disclosed herein includes components that are not designed to be modular as in prior systems. In some cases, the modular design requires interior walls and interior structures which can unnecessarily take up space. In one aspect of this disclosure, the disclosed food processor can be divided into shell components and base components. The different components within the food processor can either be attached to a base or a shell or housing. This can enable the food processor to be divided into two pieces which can enable access to the various internal components. Other improvements such as not using interior walls, a new airflow path through the food processor, a new use of a filter assembly, and so forth are disclosed herein.

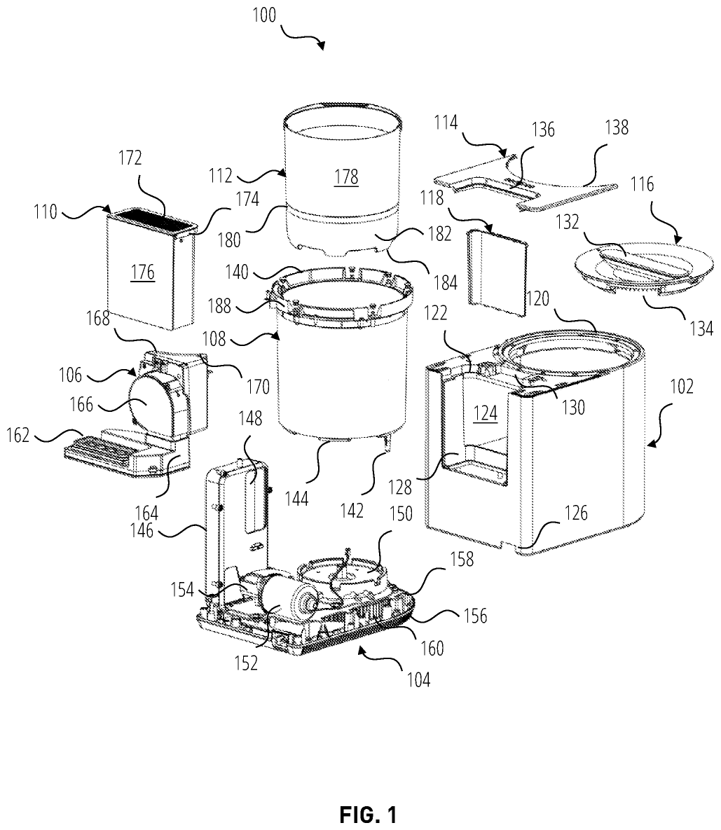

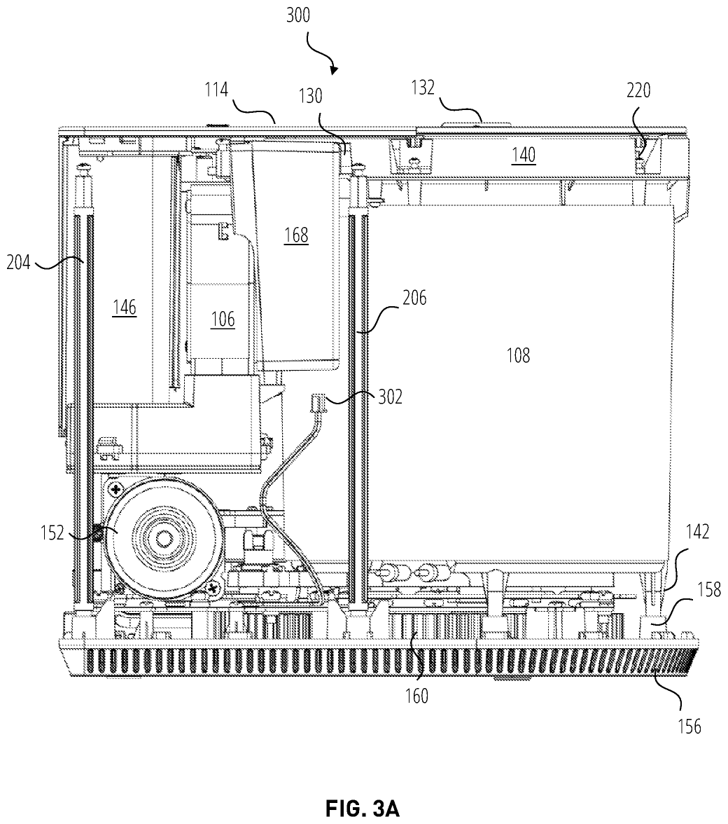

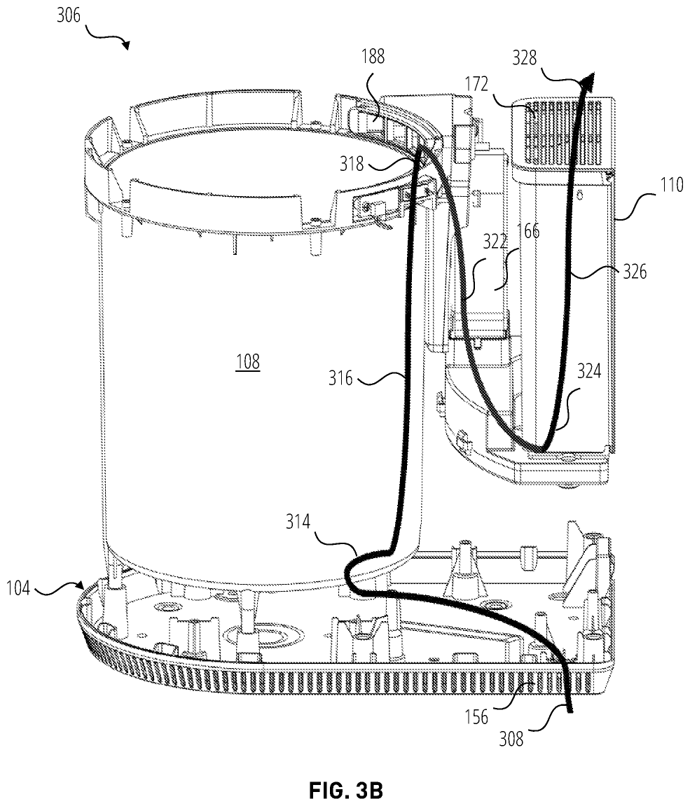

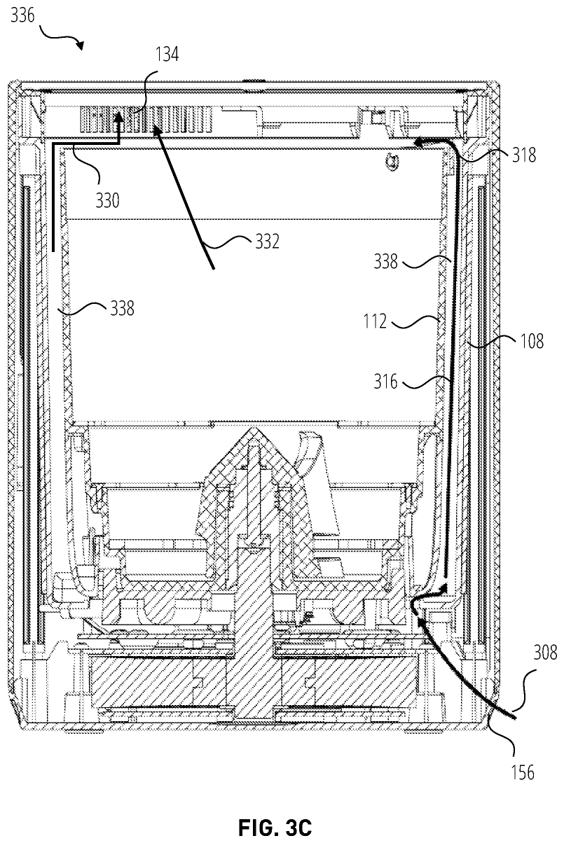

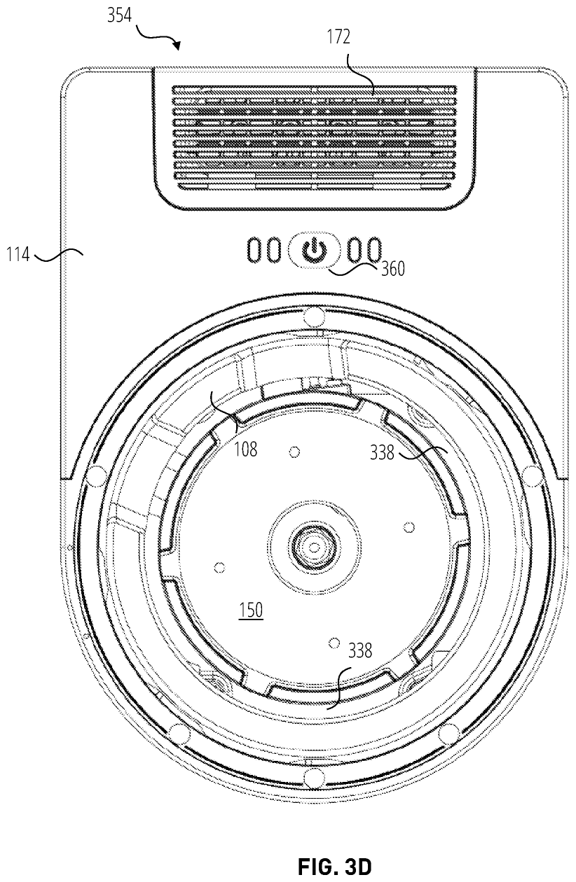

The disclosed FIG. 1 illustrates an example food processor 100 in an exploded view with a variety of different components. A food processor housing 102 is shown including a housing opening 120 which is configured to receive a bucket housing 108, which in turn receives a bucket 112. The food processor housing 102 includes a filter base cavity 128 that is configured to receive a fan assembly 106. A filter cavity 124 is shown which generally represents the space where a filter will be inserted. A button board cavity 130 is shown which is an opening or cavity that holds a button electronic board that manages a touch button (e.g., touch button 360 shown in FIG. 3D) which can be configured on the housing cover 114. The touch button 360 can be a touch sensitive button or may require a button press. The bucket housing 108 includes a bucket top rim 140 that is configured to enable the bucket housing 108 to be attached to the food processor housing 102. A power cable opening 126 is shown in the food processor housing 102 to enable a power cord (not shown) to be inserted to power the food processor 100.

One or more base air intake openings 156 are provided in the food processor base 104. The call-out number for the base air intake openings 156 is shown at the right side of the food processor base 104. In one aspect, all of the shown base air intake openings 156 can actually draw in air into the food processor housing 102. However, an alternative approach is to only enable a portion of the base air intake openings 156 to actually let in air. For example, a set of base air intake openings 156 can be configured to be open on the right side of the food processor base 104 (see FIG. 3A). FIGS. 3B-3D show an airflow from the base air intake openings 156 through the interior of the food processor housing 102 and through a channel configured between the bucket 112 and the bucket housing 108. The airflow path can enable a cooling of the motor 152 and other drivetrain 160 and transfer case 154 components. There may be multiple sets of air intake openings in the base that enable air to enter at certain locations to draw heat away from specific components such as the motor 152.

The bucket housing 108 includes a bucket housing base member 144 which can be used to stabilize or position the bucket housing 108. A bucket attachment member 142 can be used to secure the bucket housing 108 to a food processor base 104. The food processor base 104 can include an attachment member receptacle 158 which is complementary to the bucket attachment member 142 to enable the bucket housing 108 to be secured to the food processor base 104. While one bucket attachment member 142 is shown as part of the bucket housing 108, other attachment members may be included as well.

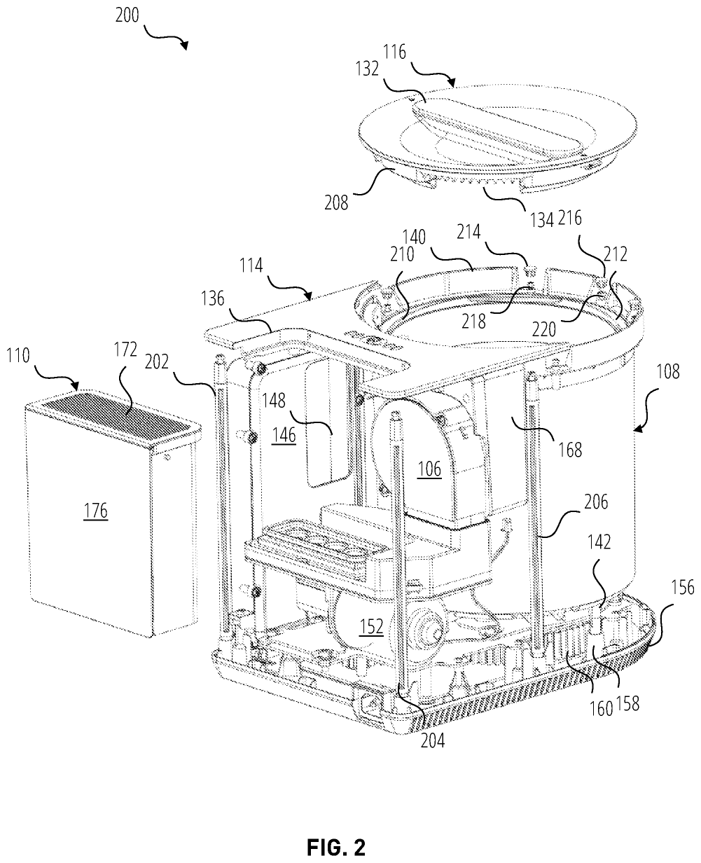

The bucket housing 108 can be used in the food processor 100 as a supporting member for infrastructure. The support feature is useful in part because of the lack of internal walls. Thus, while there are a few supporting members shown in FIGS. 2 and 3, the bucket housing 108 can be configured to be used as a supporting structure meaning that the food processor housing 102 does not need to be as strong as it otherwise might be if the food processor housing 102 was required to support the overall food processor 100.

The food processor base 104 can include other components as well. A motor 152 can be configured below and adjacent to the bucket housing 108. A transfer case 154 is shown which enables energy or power from mechanical rotation of an axle (not shown) from the motor 152 to be transferred to a drivetrain 160. The motor 152 and transfer case 154 are configured as a single unit. Above the drivetrain 160 is a heat plate 150 that can be used to transfer heat from the heat plate 150 to the bucket 112. In one aspect, the heat plate 150 and the drivetrain 160 are an integrated design in which a top piece of the drivetrain 160 acts as a stressed member which adds strength to the overall design. The drivetrain 160 and the heat plate 150 can be integrated to yield a combined structure that is configured to support the bucket housing 108. The bucket housing 108 can be floating from both the drivetrain 160 and the heat plate 150.

The various components disclosed herein are either attached to the food processor base 104 or to the food processor housing 102. For example, one or more of the bucket housing 108, the fan assembly 106, the housing cover 114 and the lid 116 can be attached to and be part of a set of housing components or shell components. The motor 152, power transfer case 154 and drivetrain 160 can be attached to the food processor base 104. This disclosure is not restricted to which specific components are associated with the food processor base 104 relative to the food processor housing 102. The approach generally is that each component is part of one of the two parts and the food processor 100 can be split into the two parts with the associated components attached to the respective part.

The fan assembly 106 can include a filter base 162 that receives or is complementary to the filter assembly 110. For example, within the filter base cavity 128, a complementary member can be used to attach the fan assembly 106 to the food processor housing 102. A fan 166 can be configured as shown in FIG. 1 with a first airflow channel 164 that receives airflow from the fan 166 and causes air to flow down through the fan 166 and then up through the filter base 162 and into the filter assembly 110. The filter assembly 110 is configured on the filter base 162. The filter assembly 110 has a filter exterior surface 176 that becomes the exterior surface of the food processor housing 102 when the filter assembly 110 is positioned in place. The use of the filter exterior surface 176 as also becoming part of the exterior surface of the food processor housing 102 is one example of how the components disclosed herein more efficiently combine to make the food processor 100.

A second airflow channel 168 brings air from a third airflow channel 170. The third airflow channel 170 receives air from the lid air flow cavity 134. Thus, when the fan 166 is on, air is drawn from the bucket 112 (and from a cavity 338 shown in FIGS. 3C and 3D between the bucket 112 and the bucket housing 108) through the lid air flow cavity 134 to the third airflow channel 170. Note the shape of the third airflow channel 170 is complementary to the circular shape of the lid air flow cavity 134. The air at this stage should be humid or filled with evaporated water through the processing of the waste food in the bucket 112. The waste food is heated via the heat plate 150 and as the food processor 100 processes the waste food, the fan 166 draws the humid air out of the bucket 112. The humid air flows from the third airflow channel 170 to the second airflow channel 168 through the fan to the first airflow channel 164. The air then flows up through the filter base 162 and through the filter assembly 110. The filter top 172 has an opening that enables the filtered air to flow out into the atmosphere around the food processor 100 from a top portion of the food processor housing 102. Note that the filter top 172 is positioned adjacent to the lid 116 and note that the filter exterior surface 176 is used as the exterior surface of the food processor housing 102. A filter support flange 174 can be used to seat the filter assembly 110 in the filter cavity 124. Inside the filter assembly 110 is the actual filter which can be any type of carbon or other filter known to those of skill in the art.

The bucket housing 108 includes a bucket housing airflow opening 188 on a top portion and at an upper rim. The bucket housing airflow opening 188 is complementary to the lid air flow cavity 134 and as shall be shown below enables airflow through the food processor housing 102 and through the cavity 338.

The bucket 112 includes a top bucket portion 178, a middle bucket portion 180 and a bottom bucket portion 182. The sides of the bucket 112 are generally smooth and the bottom bucket portion 182 includes bucket base members 184 that can be used to support the bucket 112 when the bucket 112 is placed on a countertop.

The bucket 112 can be manufactured in three different portions and the different portions can be attached in the manner disclosed in later figures.

A shell access door 118 can be used to enable a person assembling the food processor 100 access to an interior portion of the food processor housing 102 to connect electrical components from the food processor housing 102 to the base 104. The shell access door 118 can slide down into the shell cavity 124. A printed circuit board (PCB) housing 146 is shown which includes an access door 148 to enable access to the PCB or related electronics. In one aspect, the access door 148 may be a cutout in the cover of 146 that allows certain connectors to be seen and attached.

A housing cover 114 is shown with one side including a rounded edge 138 at least in part to accommodate the housing opening 120 to receive the bucket 112. A filter notch 136 is shown that is recessed to enable the filter top 172 to have access to the atmosphere to enable filtered air to escape the food processor housing 102. The lid 116 includes a lid handle 132 and the lid air flow cavity 134 that as described above provides humid air from the bucket 112 to the third airflow channel 170.

The bucket housing 108 is a supporting structure for the food processor 100 meaning it is configured to be attached to the food processor base 104 at one or more points of attachment and to be attached to the food processor housing 102 at another point of attachment, and that it provides structural support for the food processor housing 102. The configuration shown in the figures enables the food processor 100 to not need interior walls separating different components as has been used in prior art food processors. In some aspects, there are no interior walls between the motor 152 and the filter assembly 110 and no interior wall between the motor 152 and the drivetrain 160 or the bucket housing 108. Using the bucket housing 108 as a supporting structure for the food processor 100, and using the other supportive members discussed below, the overall structure can eliminate the use of interior walls from the food processor 100.

FIG. 2 illustrates a partially assembled waste food processor 200 in accordance with some aspects of this disclosure. In FIG. 2, further details of the lid 116 and other structures are shown. The lid 116 includes a lid lower circular member 208 that includes the lid air flow cavity 134 having in one example a series of optional downward projecting members to help guide the airflow to the third airflow channel 170. The lid lower circular member 208 can be vertical generally and circular in shape except for an opening defining the lid air flow cavity 134. A first support member 202, a second support member 204 and a third support member 206 provide one or more connections between the food processor base 104 and the food processor housing 102. Other connecting or support members can be used as well. In one example, there are four support members that are used.

In an alternative structure, a first sealing face 210 and a second sealing face 212 are shown which can be eccentric in shape such that a gap between the faces is reduced as the lid 116 is closed. The structure allows for a greater gap while the lid is open while still retaining the sealing benefits of having a smaller gap when the lid 116 is closed. The first sealing face 210 and/or the second sealing face 212 can deviate from a circular pattern or path. In another example, the features 210 and 212 can refer to the bucket handle and the bucket 112 may have a circular pattern or shape rather than an eccentric shape.

FIG. 2 also shows a first screw plug 214, a second screw plug 216 and a first screw 218 and a second screw 220 that are respectively complementary so that the bucket housing 108 can be attached to the food processor housing 102. There are a number of different ways that the connection can be established and the use of the screw configuration shown in FIG. 2 is one example.

FIG. 3A illustrates an assembled food processor 300 in accordance with some aspects of this disclosure. The various components are shown with in an assembled configuration. The food processor housing 102 is not shown to highlight the position of such components as the fan assembly 106, the bucket housing 108, the motor 152, the drivetrain 160, the bucket attachment member 142, the second support member 204, and third support member 206 and the attachment member receptacle 158.

FIG. 3A also shows an example of a sensor 302 that can be used to detect such aspects as humidity, temperature, weight or other characteristics of the waste food or components of the food processor 100. Sensor 302 can represent any sensor 302 or more than one sensor 302 positioned in any location. For example, a sensor 302 might be included in the lid 116 or inside the bucket 112 as a camera, or in other locations.

FIG. 3B illustrates a side view of some interior components of the food processor 306 to illustrate airflow through the food processor 306. At a first airflow position 308, air is brought in through one or more base air intake openings 156. Preferably, the base air intake openings 156 are configured on a side of the food processor 100 to ensure that the air flows past the motor and other internal components (not shown in FIG. 3B). In one aspect, the side of the food processor 100 that includes the air intake openings 156 can mean an opposite side from a side containing the bucket housing 108. In another aspect, the one or more base air intake openings 156 that actually intake air can be on a side of the food processor 100 that includes the motor 152. The airflow at a second airflow position 314 is channeled underneath the bucket housing 108 and the bucket 112 so that the air can flow in a cavity configured between the bucket 112 and the bucket housing 108 at a third airflow position 316. At a fourth airflow position 318, the air flows out the bucket housing airflow opening 188 to a fifth airflow position 322 where the fan 166 is configured to cause the air to flow in the path shown. The air in a sixth airflow position 326 flows through the filter assembly 110 and out the filter top 172 at a seventh airflow position 328.

FIG. 3C illustrates a cross-sectional view 336 of the bucket 112 and bucket housing 108 to show the airflow path. As noted above, air flows first through the base air intake openings 156 at the first airflow position 308. The air moves under the bucket 112 and into a space or airflow cavity 338 in between the bucket 112 and the bucket housing 108 at the third airflow position 316. The purpose of the airflow cavity 338 is to enable air to be heated by the heat generated by the heating heat plate 150 that heats the bucket 112 and the waste food during a waste food processing cycle. Air within the bucket 112 during a processing cycle will also become moist and generate humid air from the heated food waste. The humid air from the bucket 112 and the air from at the fourth airflow position 318 will both be drawn through the bucket housing airflow opening 188 to the filter assembly 110 by the fan 166. As shown in FIG. 3C, an eighth airflow position 330 can relate to airflow from a side of the bucket 112 and through the lid air flow cavity 134. Air from inside the bucket 112 also is drawn to the lid air flow cavity 134 via a ninth airflow position 332.

FIG. 3D illustrates a top view 354 of the food processor 100 that shows the housing cover 114, the filter top 172, the top of the heat plate 150 and the bucket housing 108. A touch button 360 is also shown which can be managed by electronics configured in the touch button board cavity 130. The airflow cavity 338 is shown from the top view for air flowing from the base air intake openings 156, by several of the internal components, and up through the airflow cavity 338. The airflow cavity 338 is configured between the bucket 112 and the bucket housing 108.

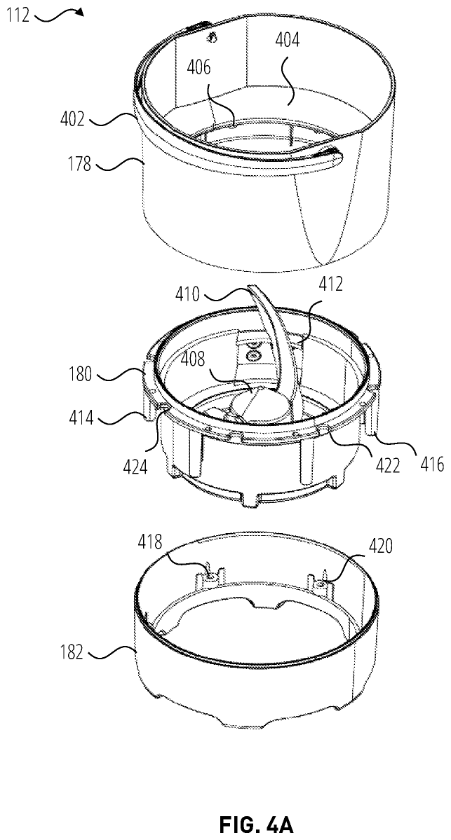

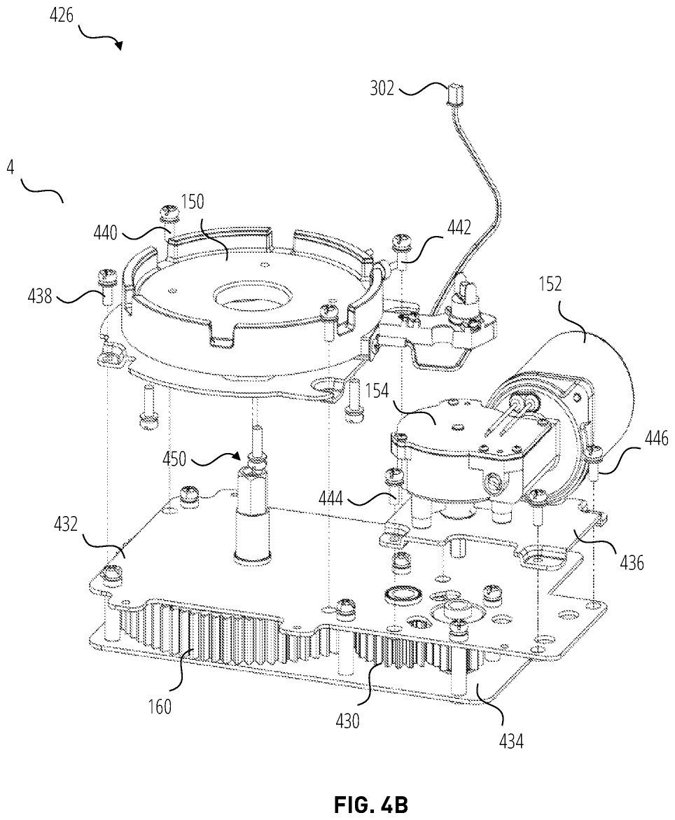

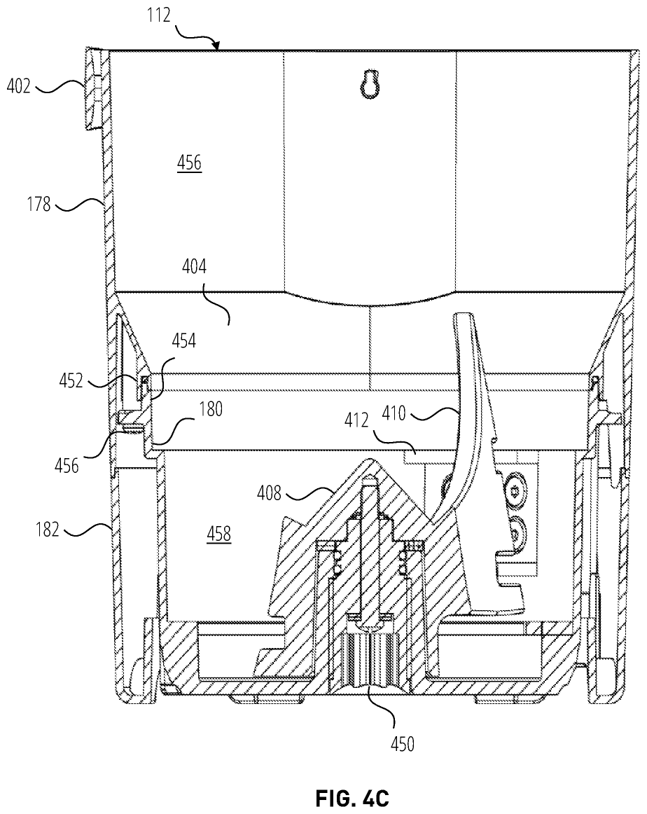

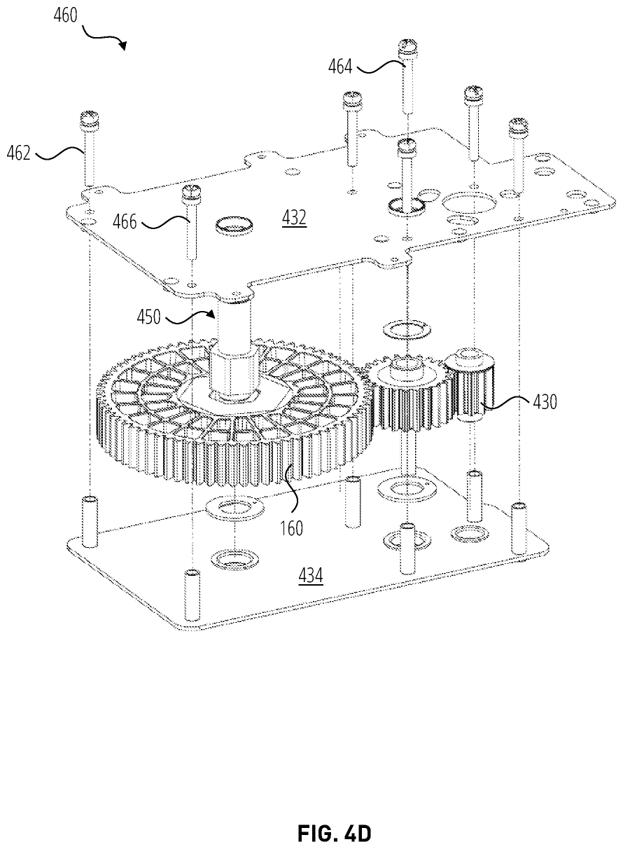

FIG. 4A illustrates an exploded view of the bucket 112 in accordance with some aspects of this disclosure. The first top bucket portion 178 is shown with a bucket handle 402 and a bucket interior flange 404 that can be used to enable a bucket top portion attachment point 406 to be used to attach the bucket middle bucket portion 180 to be attached to the top bucket portion 178. The middle bucket portion 180 is shown with a first middle portion attachment member 414 and a second middle portion attachment member 416 that can be used to receive screws to attached respectively the top bucket portion 178 to the bottom bucket portion 182.

The middle bucket portion 180 can also include a first middle portion attachment member 414 and a second middle portion attachment member 416 that can be used to attach the middle bucket portion 180 to the bottom bucket portion 182 via the first bottom portion attachment member 418 and the second bottom portion attachment member 420.

A grinding tool 408 having a grinding tool blade 410 is shown in FIG. 4A as well as an example of a type of grinding tool that can be used. A cutting member 412 or a plurality of cutting members 412 is shown extending from a side interior wall of the middle bucket portion 180. The cutting member 412 can be used or helpful in grinding the waste food during a processing cycle. There are different configurations of the grinding tool 408 and the cutting member 412. For example, U.S. patent application Ser. No. 17/404,017, filed on Aug. 17, 2021, includes a variety of different bucket designs and cutting member designs. This application is incorporated herein by reference.

FIG. 4A further shows the bottom bucket portion 182 which can include a first bottom portion attachment member 418 and a second bottom portion attachment member 420 which can be used to attach the bottom bucket portion 182 to the middle bucket portion 180.

FIG. 4B illustrates an exploded view 426 of the heat plate 150 and drivetrain 160. The drivetrain 160 can include features such as a top bracket of the drivetrain 432 and a bottom bracket of the drivetrain 434 that enables a series of gears 430 (i.e., one or more gears) to interact as driven by the motor 152 through a transfer case 154. A drive column 450 rotates to cause the grinding tool 408 to grind waste food in the bucket 112. Screws 438, 440, 442 are shown to attach the heat plate 150 to the top brackets of the drivetrain 432. A motor bracket 436 is attached to the motor 152 and transfer case 154. Screws 444, 446 can be used to attach the motor bracket 436 to the top bracket of the drivetrain 432. The exploded view 426 illustrates an example way in which a motor 152, drivetrain 160 and heating heat plate 150 can be assembled. Other structures are contemplated as well.

FIG. 4C illustrates a cross-sectional view of the bucket 112. Here, the bucket interior flange 404 is shown extending from an interior bucket wall 456 (of the top bucket portion 178) that is part of the top bucket portion 178. A circular notch 452 is configured as part of the bucket interior flange 404 that is complementary to a circular vertical member 454 that is configured as part of the middle bucket portion 180. The circular vertical member 454 is complementary to the circular notch 452 such that the top bucket portion 178 and the middle bucket portion 180 can be connected using one or more screws 456.

The grinding tool base 408 and the grinding tool blade 410 as shown as being connected to the drive column 450. The use of the cutting member 412 as extending from an interior bucket wall 458 (of the bottom bucket portion 182) is also shown.

FIG. 4D illustrates an exploded view of the drivetrain and set of gears 460. The top bracket of the drivetrain 432 and the bottom bracket of the drivetrain 434 are shown separated from the set series of gears 430 and the drivetrain 160. The drive column 450 is shown as well as a set of screws 462, 464, 466 which attach the top bracket of the drivetrain 432 to the bottom bracket of the drivetrain 434. Other screws are also shown.

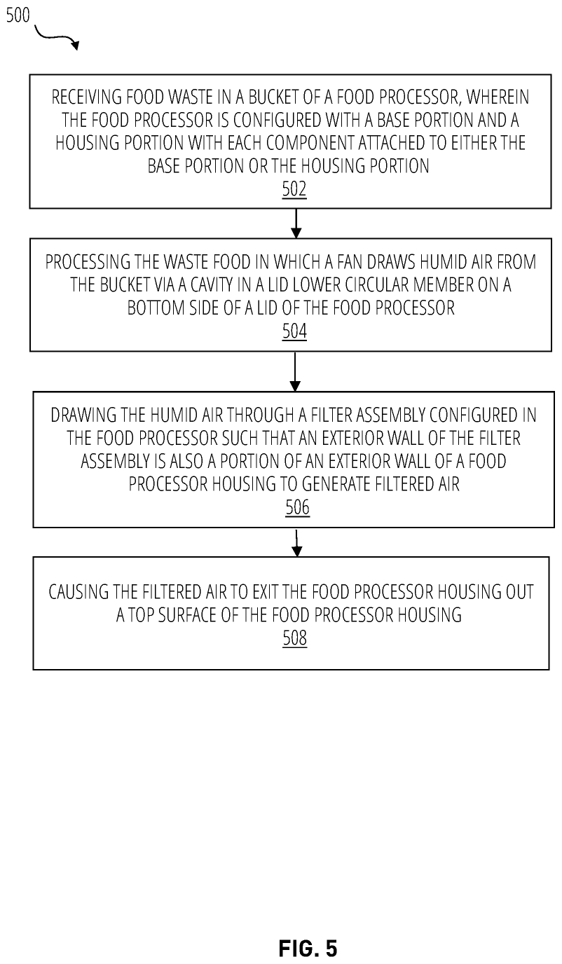

FIG. 5 illustrates a method 500 in accordance with some aspects of this disclosure. The method can be practiced by a food processor 100 including any one or more of the disclosed sub-components. The method 500 can include receiving food waste in a bucket 112 of a food processor 100, wherein the food processor 100 is configured with a base portion or food processor base 104 and a food processor housing 102 or housing portion with each component of the food processor 100 attached to either the food processor base 104 or the food processor housing 102 (502), processing the waste food in which a fan 166 draws humid air from the bucket 112 via a cavity such as the lid air flow cavity 134 in a lid lower circular member 208 on a bottom side of a lid 116 of the food processor 100 (504). The method 500 can further include drawing the humid air through a filter assembly 110 configured in the food processor 100 such that a filter exterior surface 176 of the filter assembly 110 is also a portion of an exterior wall of the food processor housing 102 to generate filtered air (506) and causing the filtered air to exit the food processor housing 102 out a top surface or filter exterior surface 176 of the food processor housing 102 (508).

The method can further include other steps that are part of a process of recycling waste food such as operating a recycling process of heating, moving a grinding tool, and turning on a fan 166 to break down the waste food and draw out the water content from the waste food to generate the rich organic soil or processed material. The method can include filtering and using the various components disclosed herein.

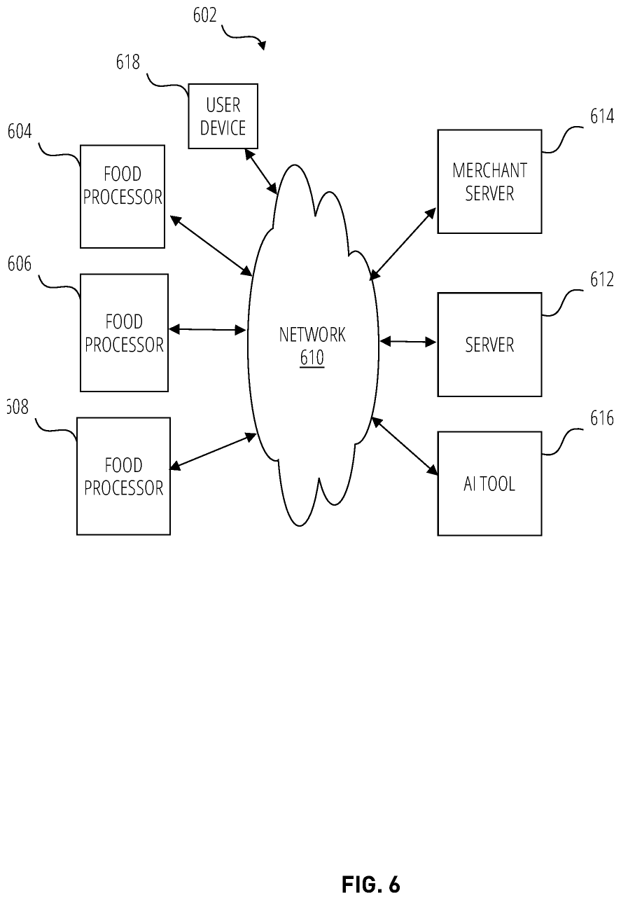

FIG. 6 illustrates a data management system 602 including one or more food processors 604, 606, 608, a network 610, a data management server 612, a merchant server 614, and an artificial intelligence (AI) tool 616. ChatGPT is one example of an AT tool 616. A user device 618 can be used with an application or to access the data management server 612. The one or more food processors 604, 606, 608 can be like the food processor 100 discussed above. The one or more food processors 604, 606, 608 can include a communication component that enables wired communication or wireless communication via WiFi, cellular, BlueTooth or some other wireless protocol. The sensor 302 shown in FIG. 3 can represent any one or more sensors that can be used to obtain images of waste rood, weights of waste food, food detection sensors, humidity sensors, temperature sensors and so forth. The sensors 302 can evaluate and report on what waste food people are processing, how much, when and/or for what duration, how many cycles per time frame, where the user buys the food from (if possible). The data management server 612 can obtain and evaluate data from the one or more food processors 604, 606, 608 and provide advertising and services to the user device 618 and/or the merchant server 614 based on the data. For example, the merchant server 614 may relate to a grocery store and an entity running the data management server 612 can sell business data to the grocery store. Such data can help in stocking, ordering, delivery and other business decisions at a micro level or a macro level knowing what waste food is being processed. The data can even help a merchant server 614 to target individual advertisements and incentives to individual customers based on what food they have been processing. A customer may have a user device 618 with an application for the merchant server 614 and can receive notices when a fresh load of bananas, cereal or specialty drink have arrived at the store. The advertisement can be based on the waste food detected by the sensor 302 in the food processor 100 of the user.

In one example, the data management server 612 may also receive purchasing data from a merchant server 614 that identifies what products the user has purchased. The user may opt into a program in which they can track the food items they have purchased. The one or more food processors 604, 606, 608 can provide data on what food they have consumed or are processing as waste food. The data management server 612 can determine or make predictions using, for example, artificial intelligence or machine learning models to infer or estimate what food the user still have in their kitchen. The AI tool 616 such as ChatGPT can be queried with some of the basic food items that are expected to be in the user's kitchen based on the business data and recipes can be suggested for the user on the user device 618. The data management system 602 may query the user to confirm of they have a particular item if the probability of that item being in the kitchen is low, and then based on the response to that query, a recipe can be suggested. As an alternative, an interaction with the user via the user device 618 could suggest that all they need is pineapple and they can make a certain meal.

The data obtained by the data management server 612 can be used to predict food supply, suggest food options to purchase, suggest recipes, suggest sizing for a recipe (you only have enough if you cut this recipe in half), or other interactions to help guide users to efficiency use their food supply. The data gathered can be individualized or anonymized for secrecy in some cases. Users can opt into a more robust assistance program in which the data management server 612 may be able to let them know what items they are out of or short on (such as milk, eggs, flower, etc.). The data management server 612 could also tap into other sensors in the kitchen such as a refrigerator sensor or sensors in cupboards that identify food items and supply status. The data management server 612 can aggregate data from multiple users, organize the data by neighborhood or regionally, such as in an area most likely served by a particular grocery store, and use machine learning to provide individual guidance to users on their purchasing, cooking and usage of food in general. In some cases, the data management server 612 will receive feedback from the sensor 302 on a food processor 100 or one or more food processors 604, 606, 608, and receive data from one other source such as a merchant record of purchases, or data from another appliance in the kitchen, or from user input, and generate guidance on food choices such as recipes, shopping lists, suggested food purchases, timing of food purchases or food use (such as when a particular item may go bad), suggestions on the use of the food processor 100 and so forth.

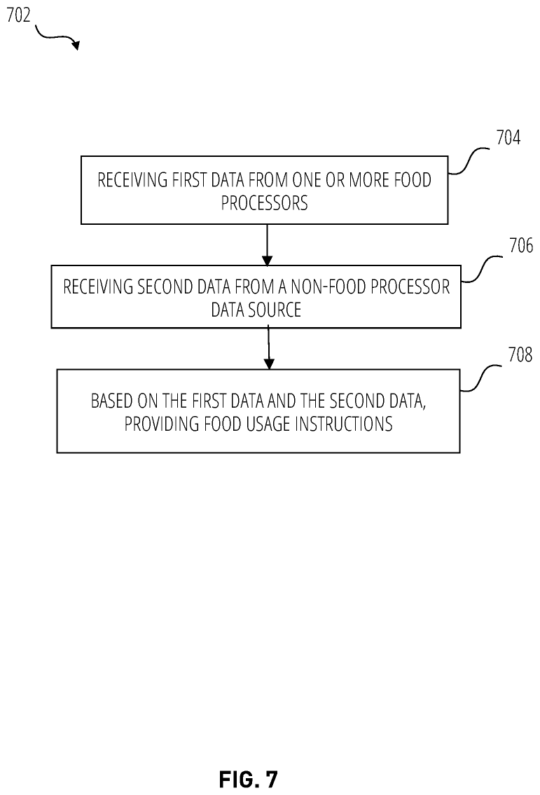

FIG. 7 illustrates a method 702 for managing food use. The method 702 can include receiving first data from one or more food processors 604, 606, 608 (702), receiving second data from a non-food processor data source (704) and based on the first data and the second data, providing food usage instructions to a user device 618 (706). The non-food processor data source can be any data source described herein such as user input, a separate user image taken with a user device 618, data from an appliance, food data from a merchant server 614, data from a local grocery store, stocking data, supply scheduling data for a grocery store, data from an AI tool 616, or other data source. The food usage instructions can be of any type such as recipe suggestions, sizing suggestions, food needs for certain recipes, food that is low in supply in the kitchen, timing instructions for either a recipe to be made or based on delivery and stock in a local grocery store, and so forth.

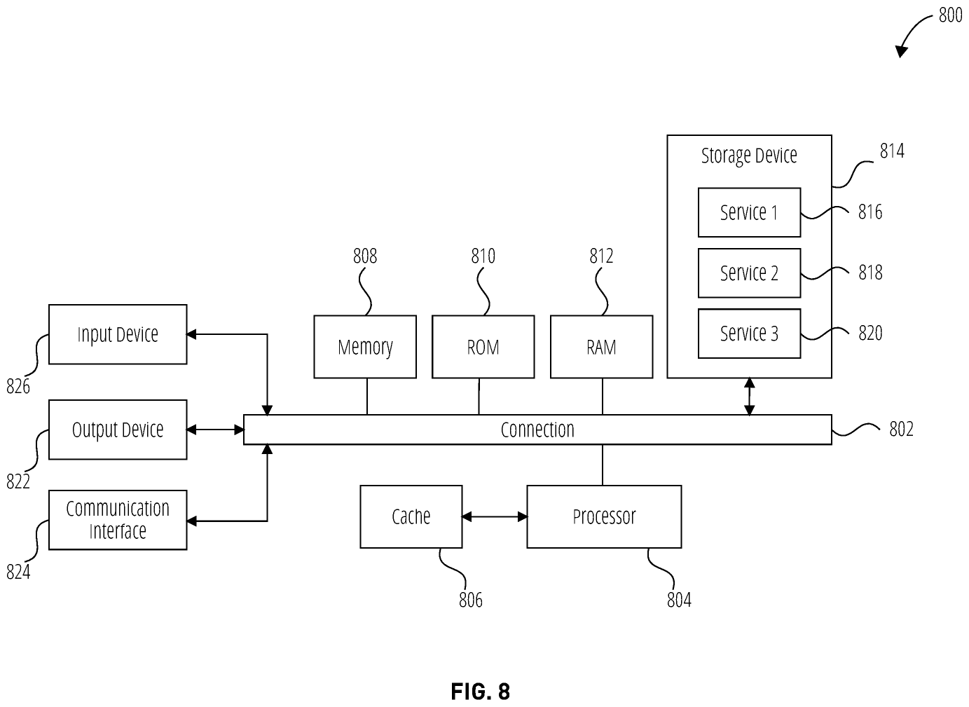

FIG. 8 shows an example of computing system 800, which can be for example any computing device making up a control system of the food processor 100, or any component thereof in which the components of the system are in communication with each other using connection 802. Connection 802 can be a physical connection via a bus, or a direct connection into processor 804, such as in a chipset architecture. Connection 802 can also be a virtual connection, networked connection, or logical connection.

In some embodiments, computing system 800 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 800 includes at least one processing unit (CPU or processor) 804 and connection 802 that couples various system components including system memory 808, such as read-only memory (ROM) 810 and random access memory (RAM) 812 to processor 804. Computing system 800 can include a cache of high-speed memory 806 connected directly with, in close proximity to, or integrated as part of processor 804.

Processor 804 can include any general purpose processor and a hardware service or software service, such as services 816, 818, and 820 stored in storage device 814, configured to control processor 804 as well as a special-purpose processor where software instructions are incorporated into the actual processor design. Processor 804 may essentially be a completely self-contained computing system, containing multiple cores or processors, a bus, memory controller, cache, etc. A multi-core processor may be symmetric or asymmetric.

To enable user interaction, computing system 800 includes an input device 826, which can represent any number of input mechanisms, such as a microphone for speech, a touch-sensitive screen for gesture or graphical input, keyboard, mouse, motion input, speech, etc. Computing system 800 can also include output device 822, which can be one or more of a number of output mechanisms known to those of skill in the art. In some instances, multimodal systems can enable a user to provide multiple types of input/output to communicate with computing system 800. Computing system 800 can include communication interface 824, which can generally govern and manage the user input and system output. There is no restriction on operating on any particular hardware arrangement, and therefore the basic features here may easily be substituted for improved hardware or firmware arrangements as they are developed.

Storage device 814 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 814 can include software services, servers, services, etc., that when the code that defines such software is executed by the processor 804, it causes the system to perform a function. In some embodiments, a hardware service that performs a particular function can include the software component stored in a computer-readable medium in connection with the necessary hardware components, such as processor 804, connection 802, output device 822, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Claim clauses associated with this disclosure include:

Clause 1. A food processor comprising: a base; a housing configured to be attached to the base; a bucket; a bucket housing configured receive the bucket and to be attached to the base and configured to be a supporting structure for the food processor; a lid configured on a top portion of the food processor, wherein the lid comprises a lid lower circular member on a bottom portion of the lid in which the lid lower circular member has a lid air flow cavity configured to enable humid air from the bucket to flow to a fan; and a filter that receives and filters the humid air.

Clause 2. The food processor of clause 1, wherein the filter is configured in a filter assembly that is removable and that has an exterior surface that, when installed, becomes a portion of an exterior wall of the housing.

Clause 3. The food processor of any previous clause, wherein the housing comprises no internal structural walls.

Clause 4. The food processor of any previous clause, wherein the bucket housing is configured to be a supportive structure for the food processor.

Clause 5. The food processor of any previous clause, where the food processor is separable between the base and the housing.

Clause 6. The food processor of any previous clause, wherein the lid has one of a circular or an eccentric sealing surface between the lid and the bucket.

Clause 7. The food processor of any previous clause, further comprising: a drivetrain; and a heat plate.

Clause 8. The food processor of clause 7 or any previous clause, wherein the drivetrain and the heat plate are integrated to yield an integrated structure that is configured to support the bucket housing.

Clause 9. The food processor of any previous clause, wherein an airflow path is configured to draw air from the bucket first via the lid air flow cavity, second through a fan configured adjacent to the bucket housing, third to a filter base, fourth up through a filter configured on the filter base and fifth out through a top surface of the food processor.

Clause 10. The food processor of clause 9 or any previous clause, wherein the top surface of the food processor is separate from the lid.

Clause 11. The food processor of any previous clause, wherein an airflow path is defined from an air intake opening in the base, through an internal portion of the base, up into a cavity configured between the bucket and the bucket housing, and through the lid air flow cavity to the fan and the filter.

Clause 12. A method comprising: receiving food waste in a bucket of a food processor, wherein the food processor is configured with a base, a lid and a housing; processing the food waste, wherein a fan draws humid air from a bucket via a lid air flow cavity in the lid on a bottom side of the lid; drawing the humid air through a filter assembly configured in the food processor such that a filter exterior surface of the filter assembly is configured to also become a portion of an exterior wall of the housing to generate filtered air; and causing the filtered air to exit the housing out a top surface of the housing.

Clause 13. The method of clause 12, wherein each component of the food processor is attached to either the base or the housing.

Clause 14. The method of any of clauses 12-13, wherein the top surface of the housing is separate from the lid.

Clause 15. The method of any of clauses 12-14, wherein an airflow path is configured to draw the humid air from the bucket first via the lid air flow cavity, second through a fan configured adjacent to the bucket, third to a filter base, fourth up through a filter configured on the filter base and fifth out through the top surface of the housing.

Clause 16. The method of any of clauses 12-15, wherein the food processor further comprises a bucket housing that is configured to be a supportive structure for the food processor.

Clause 17. The method of any of clauses 12-16, wherein the housing comprises no internal structural walls and wherein a bucket housing is configured to be a supportive structure in the food processor.

Clause 18. The method of any of clauses 12-17, wherein the lid is configured on a top portion of the food processor, wherein the lid comprises a lid lower circular member on a bottom portion of the lid in which the lid lower circular member has the lid air flow cavity configured to enable the humid air from the bucket to flow to a fan.

Clause 19. The method of any of clauses 12-18, wherein the filter assembly is removable.

Clause 20. The method of any of clauses 12-19, wherein the food processor comprises an integrated heat plate and drivetrain configured below the bucket.

What is claimed is:

1. A food processor comprising:
a base;
a housing configured to be attached to the base;
a bucket;
a bucket housing configured receive the bucket and to be attached to the base and configured to be a supporting structure for the food processor;
a lid configured on a top portion of the food processor, wherein the lid comprises a lid lower circular member on a bottom portion of the lid in which the lid lower circular member has a lid air flow cavity configured to enable humid air from the bucket to flow to a fan; and
a filter that receives and filters the humid air.

2. The food processor of claim 1, wherein the filter is configured in a filter assembly that is removable and that has an exterior surface that, when installed, becomes a portion of an exterior wall of the housing.

3. The food processor of claim 1, wherein the housing comprises no internal structural walls.

4. The food processor of claim 1, wherein the bucket housing is configured to be a supportive structure for the food processor.

5. The food processor of claim 1, where the food processor is separable between the base and the housing.

6. The food processor of claim 1, wherein the lid has one of a circular or an eccentric sealing surface between the lid and the bucket.

7. The food processor of claim 1, further comprising:
a drivetrain; and
a heat plate.

8. The food processor of claim 7, wherein the drivetrain and the heat plate are integrated to yield an integrated structure that is configured to support the bucket housing.

9. The food processor of claim 1, wherein an airflow path is configured to draw air from the bucket first via the lid air flow cavity, second through a fan configured adjacent to the bucket housing, third to a filter base, fourth up through a filter configured on the filter base and fifth out through a top surface of the food processor.

10. The food processor of claim 9, wherein the top surface of the food processor is separate from the lid.

11. The food processor of claim 1, wherein an airflow path is defined from an air intake opening in the base, through an internal portion of the base, up into a cavity configured between the bucket and the bucket housing, and through the lid air flow cavity to the fan and the filter.

12. A method comprising:
receiving food waste in a bucket of a food processor, wherein the food processor is configured with a base, a lid and a housing;
processing the food waste, wherein a fan draws humid air from a bucket via a lid air flow cavity in the lid on a bottom side of the lid;
drawing the humid air through a filter assembly configured in the food processor such that a filter exterior surface of the filter assembly is configured to also become a portion of an exterior wall of the housing to generate filtered air; and
causing the filtered air to exit the housing out a top surface of the housing.

13. The method of claim 12, wherein each component of the food processor is attached to either the base or the housing.

14. The method of claim 12, wherein the top surface of the housing is separate from the lid.

15. The method of claim 12, wherein an airflow path is configured to draw the humid air from the bucket first via the lid air flow cavity, second through a fan configured adjacent to the bucket, third to a filter base, fourth up through a filter configured on the filter base and fifth out through the top surface of the housing.

16. The method of claim 12, wherein the food processor further comprises a bucket housing that is configured to be a supportive structure for the food processor.

17. The method of claim 12, wherein the housing comprises no internal structural walls and wherein a bucket housing is configured to be a supportive structure in the food processor.

18. The method of claim 12, wherein the lid is configured on a top portion of the food processor, wherein the lid comprises a lid lower circular member on a bottom portion of the lid in which the lid lower circular member has the lid air flow cavity configured to enable the humid air from the bucket to flow to a fan.

19. The method of claim 12, wherein the filter assembly is removable.

20. The method of claim 12, wherein the food processor comprises an integrated heat plate and drivetrain configured below the bucket.
